(19) United States
(12) Patent Application Publication
(10) Pub. No.: US 2016/0151703 A1
(43) Pub. Date: Jun. 2, 2016

(54) SYSTEMS AND METHODS FOR PERFORMING PUZZLE GAMES

(71) Applicant: LINE Plus Corporation, Seongnam-si (KR)

(72) Inventors: Yong Hyun LEE, Seongnam-si (KR); Byeong Yong OH, Seongnam-si (KR)

(21) Appl. No.: 14/837,397

(22) Filed: Aug. 27, 2015

(30) Foreign Application Priority Data
Nov. 27, 2014 (KR) 10-2014-0167837

(51) Int. Cl. A63F 9/06; A63F 13/21

(52) U.S. Cl. CPC A63F 9/0612; A63F 13/21

(57) ABSTRACT

A puzzle game system and a puzzle game method are provided. The puzzle game method implemented by a computer includes displaying, by a processor of the computer, a block map on a screen of the puzzle game system, the block map configured so that a plurality of blocks form a plurality of columns and a plurality of rows, determining, by the processor, location information and direction information based on input from a user, and moving, by the processor, blocks in at least one of one column and one row based on the location information and the direction information to a first side of the block map.

### CROSS-REFERENCE TO RELATED APPLICATIONS

A claim for priority under 35 U.S.C. §119 is made to Korean Patent Application No. 10-2014-0167837 filed Nov. 27, 2014, in the Korean Intellectual Property Office, the entire contents of which are hereby incorporated by reference.

### BACKGROUND

Example embodiments of the inventive concepts described herein relate to systems and/or methods for performing puzzle games.

A puzzle game refers to a game which test a user's ingenuity or knowledge to piece together in a logical way (in other words, test a user's way of solving questions or finding solutions through logical thinking according to rules provided from a computer). For example, a typical three match block game progresses in a way of removing blocks of one or more locations and filling the one or more locations, at which the blocks are removed, with other blocks by moving and disposing blocks so that the three blocks having the equivalent type or the same type are continuously neighbored (up and down or left and right).

### SUMMARY

Some example embodiments of the inventive concepts provide a puzzle game system for providing a service to move the blocks formed by one column or one row in a block map, which is configured by a plurality of blocks forming a plurality of columns and a plurality of rows, and to progress a puzzle game in a way of removing corresponding blocks when each block in the combined blocks have the equivalent or same type and the combined blocks have a particular shape (e.g., a shape set per game instance) and/or a method for performing such puzzle games.

According to an example embodiment of the inventive concepts, a method of performing a puzzle game implemented by a computer includes displaying, by a processor of the computer, a block map on a screen, the block map configured so that a plurality of blocks form a plurality of columns and a plurality of rows, determining. by the processor, location information and direction information based on input from a user, and moving, by the processor, blocks in at least one of one column and one row based on the location information and the direction information, to a first side of the block map, wherein the moving blocks includes, when moving the blocks in at least one of the one column and the one row to the first side, controlling some of the blocks in the at least one of the one column and the one row to disappear from a first end of the block map at the first side, and disposing new blocks of a same number as that of the disappeared blocks on a blank space of a second side of the block map, the second side being opposite to the first side.

According to an example embodiment of the inventive concepts, a non-transitory computer-readable medium having stored thereon instructions that when executed by a processor to cause a processor to perform the foregoing method may be provided.

According to an example embodiment of the inventive concepts, a puzzle game system implemented with a computer includes a memory having computer-readable instructions stored thereon, and at least one processor configured to execute the computer-readable instructions which configure the processor to move blocks in at least one of one column and one row, the one column (or the row) based on location information and direction information, to a first side of a block map, the block map including a plurality of blocks forming a plurality of columns and a plurality of rows, the location information and the direction information determined based on input from a user, wherein when moving the blocks included in the at least one of the one column and the one row to the first side, the processor is configured to control some of the blocks in the at least one of the one column and the one row to disappear from a first end of the block map at the first side, and dispose new blocks of a same number as that of the disappeared blocks on a blank space of the second side of the block map, the second side being opposite to the first side.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a drawing illustrating a puzzle game screen according to an example embodiment of the inventive concepts;

FIGS. 2 and 3 are drawings illustrating a process of moving blocks according to an example embodiment of the inventive concepts;

FIG. 4 is a drawing illustrating a shape of a block map according to an example embodiment of the inventive concepts;

FIG. 5 is a drawing illustrating blocks classified through various symbols according to an example embodiment of the inventive concepts;

FIG. 6 is a drawing illustrating a process in which a user moves blocks of a block map according to an example embodiment of the inventive concepts;

FIG. 7 is a drawing illustrating a process of removing the equivalent or same type of blocks when the blocks each are of the equivalent or same type and are arranged in a desired shape and a process of making new blocks appear according to an example embodiment of the inventive concepts;

FIG. 8 is a drawing illustrating a process of removing blocks by new blocks according to an example embodiment of the inventive concepts;

FIG. 9 is a block diagram illustrating a configuration of a puzzle game system according to an example embodiment of the inventive concepts; and

FIG. 10 is a flowchart illustrating an operation of a puzzle game method according to an example embodiment of the inventive concepts.

### DETAILED DESCRIPTION

Various example embodiments will be described in detail with reference to the accompanying drawings. The inventive concepts, however, may be embodied in various different forms, and should not be construed as being limited only to the illustrated example embodiments. Rather, these example embodiments are provided as examples so that this disclosure will be thorough and complete, and will fully convey the inventive concepts to those skilled in the art. Accordingly, known processes, elements, and techniques are not described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Some example embodiments disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

Hereinafter, a description will be given in detail for some example embodiments of the inventive concepts with reference to the accompanying drawings.

Example embodiments of the inventive concepts relate to new puzzle game methods and/or systems therefor.

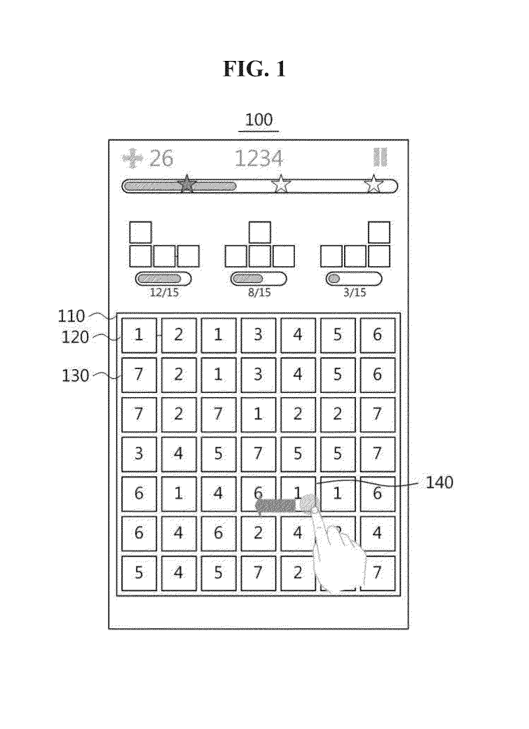

FIG. 1 is a drawing illustrating a puzzle game screen according to an example embodiment of the inventive concepts. A puzzle game screen 100 of FIG. 1 may be a screen of a user terminal such as a smart phone and may refer to an example of a screen which displays a block map 110 configured so that a plurality of blocks form a plurality of columns and a plurality of rows. Each of quadrangles on which numerals are drawn in FIG. 1 may correspond to one block. For example, the numeral ‘1’ is drawn on a block 120 of a first column and a first row, and the numeral ‘7’ is drawn on a block 130 of the first column and a second row.

In a puzzle game method according to an example embodiment of the inventive concepts, a puzzle game system may determine location information and direction information which are input from a user. The puzzle game system may move blocks included in one column (or one row) determined based on the location information and the direction information to an upper side (or a left side) or a lower side (or a right side) of the block map 110 based on the direction information. For example, the puzzle game screen 100 may refer to an example of generating a touch & drag event in which the user touches a location corresponding to a block 140 of a 5^{th} column and a 5^{th} row on the block map 110 and drags the touched location in a left direction.

In this case, the puzzle game system (e.g., a user terminal) which services a puzzle game may determine the 5^{th} row or the 5^{th} column including the block 140 based on the location of the touch and may recognize that the user moves the 5^{th} row in the left direction based on the direction (left direction) of the drag.

In this case, all blocks of the 5^{th} row may be moved in the left direction. The number of sections by which the blocks are moved may be determined according to a drag degree in the touch & drag event. For example, when the user drags a location longer, blocks of the selected row or column may move a distance of more blocks in the selected direction (e.g., the left direction). Herein, one section may correspond to a region where one block is disposed.

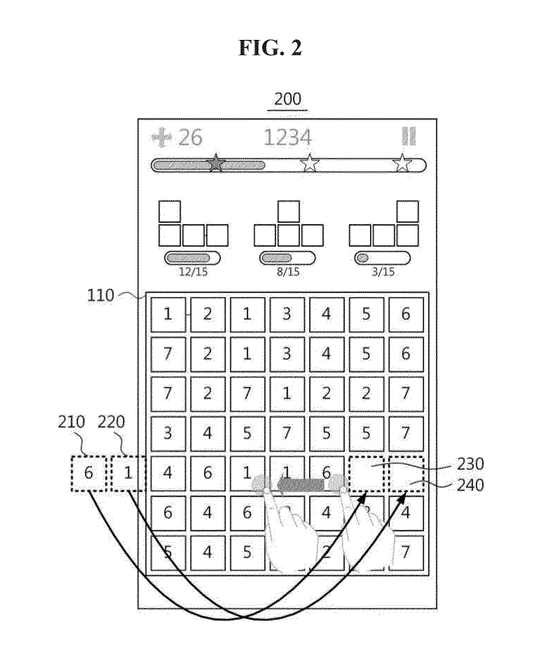

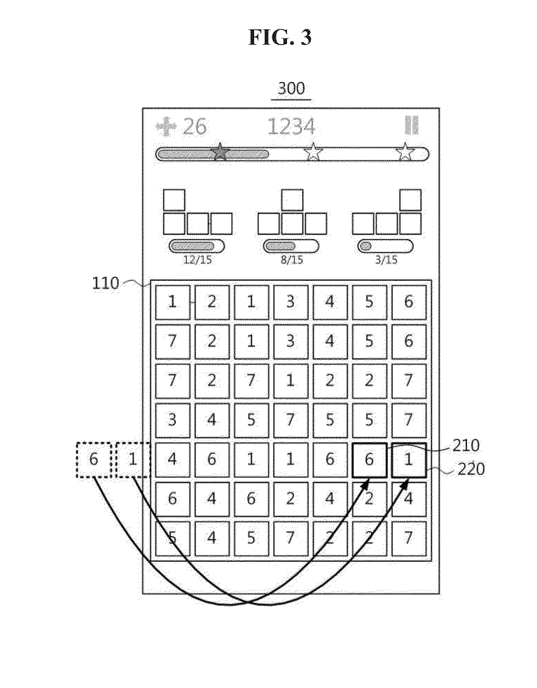

FIGS. 2 and 3 are drawings illustrating a movement process of blocks according to an example embodiment of the inventive concepts. A puzzle game screen 200 of FIG. 2 refers to an example in which two blocks 210 and 220 depart and disappear from a block map 110 as two sections are moved in the left direction of blocks of a 5^{th} row on a puzzle game screen 100 of FIG. 1. Also, as the two sections are moved in the left direction of the blocks of the 5^{th} row, two blank spaces 230 and 240 may occur in the 5^{th} row. The two blocks 210 and 220 which disappear may be disposed in the two blank spaces 230 and 240.

In this case, a puzzle game screen 300 of FIG. 3 refers to an example in which the two blocks 210 and 220 which disappear are disposed again on the block map 110.

As such, when moving blocks included in one column (or one row) to an upper side (or a left side) of a block map (e.g., the block map 110), the puzzle game system may dispose blocks, which depart or disappear from a upper end (or a left end) of the block map among the blocks of the one column (or the one row), on a blank space of a lower side (or a right side) of the block map. Also, when moving blocks included in one column (or one row) to a lower side (or a right side) of the block map, the puzzle game system may dispose blocks, which depart or disappear from a lower end (or a right end) of the block map among the blocks of the one column (or the one row), on a blank space of an upper side (or a left side) of the block map.

This may mean that all rows and all columns of the block map are displayed on a screen in a logical and rotating manner in which the first block and the last block are connected with each other.

In another example embodiment of the inventive concepts, when blocks depart from a block map, new blocks may be disposed on a blank space. For one example, the new blocks may be selected in a random way and may be disposed on the blank space. For another example, the new blocks may be selected according to types of blocks displayed on a screen or the number of the blocks.

FIGS. 1 to 3 illustrate an example in which the block map is implemented with the quadrangle. However, the block map may not be limited to the quadrangle. For example, the block map may also be configured so that the number of blocks included in a first column from among a plurality of columns is different from the number of blocks included in a second column from among the plurality of columns or so that the number of blocks included in a first row from among a plurality of rows is different from the number of blocks included in a second row from among the plurality of rows.

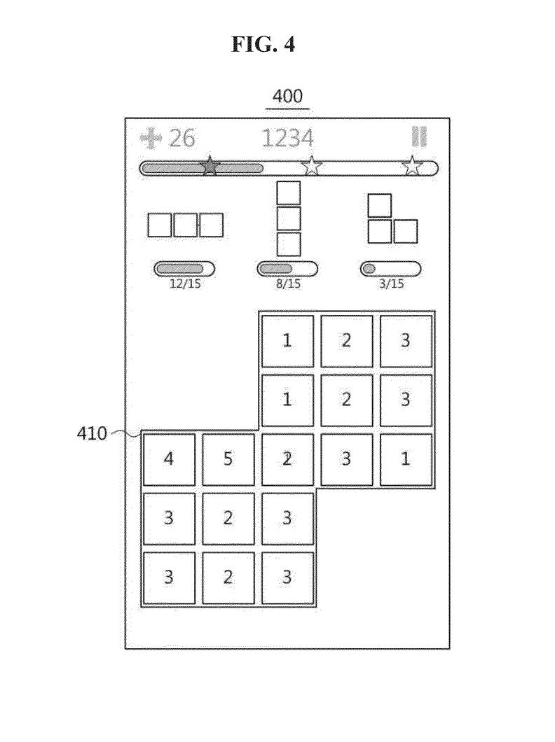

FIG. 4 is a drawing illustrating a shape of a block map according to an example embodiment of the inventive concepts. A puzzle game screen 400 displays an example of a block map 410 of a different shape.

In the block map 410, while the number of blocks included in each of a first column, a second column, a 4^{th} column, and a 5^{th} column is ‘3’, the number of blocks included in a 3^{rd} column may be ‘5’. Also, in the block map 410, while the number of blocks included in each of a first row, a second row, a 4^{th} row, and a 5^{th} row is ‘3’, the number of blocks included in a 3^{rd} row may be ‘5’.

As such, when a block map is configured with a shape which is different from a quadrangle, at least one of a plurality of columns (or rows) may include blocks of a different number from that of another of the plurality of columns (or rows).

As such, in some example embodiments of the inventive concepts, block maps with various shapes may be configured.

As shown in FIGS. 1 to 4, a plurality of blocks included in the block map may be classified into different types of blocks. For example, FIGS. 1 to 3 illustrate blocks classified by 7 numerals such as the numeral ‘1’ to the numeral ‘7’. FIG. 4 illustrates blocks classified by 5 numerals such as the numeral ‘1’ to the numeral ‘5’.

The above-described example embodiments of the inventive concepts describe examples in which blocks are classified using numerals. However, blocks may be classified in various ways through colors, shapes, or displayed symbols, characters, or numerals, and the like.

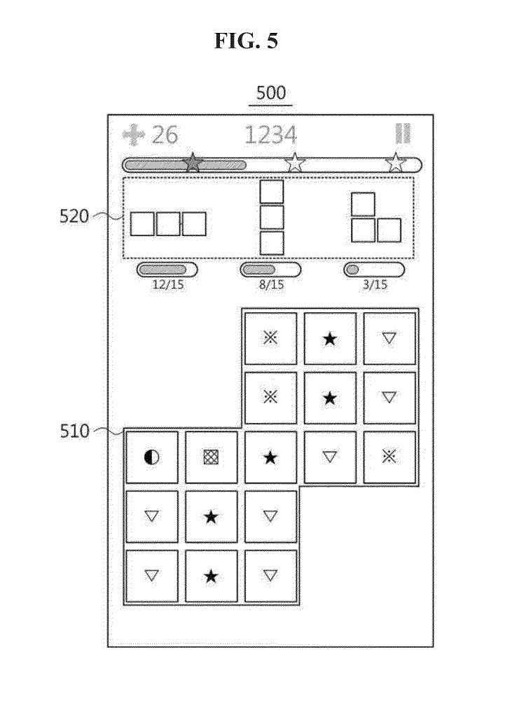

FIG. 5 is a drawing illustrating blocks classified through various symbols according to an example embodiment of the inventive concepts. A block map 510 displayed on a puzzle game screen 500 may include blocks on which various symbols are drawn.

As such, in some example embodiments of the inventive concepts, blocks may be classified in various ways. In this case, blocks may be classified by simultaneously using several conditions such as colors and symbols so that users may more easily classify different types of blocks.

Also, as shown in FIGS. 1 to 5, a desired (or alternatively, predetermined) shape of combined blocks may be displayed to users. For example, a dotted box 520 of FIG. 5 indicates desired (or alternatively, predetermined) three shapes of combined blocks.

In this case, the user may move blocks of the block map so that the combined blocks each are of the equivalent or same type and are arranged in a given or desired shape. When the combined blocks each are of the equivalent or same type and are arranged in the given or desired shape, the corresponding blocks may be removed. A score according to the removal of the blocks may be provided to the user.

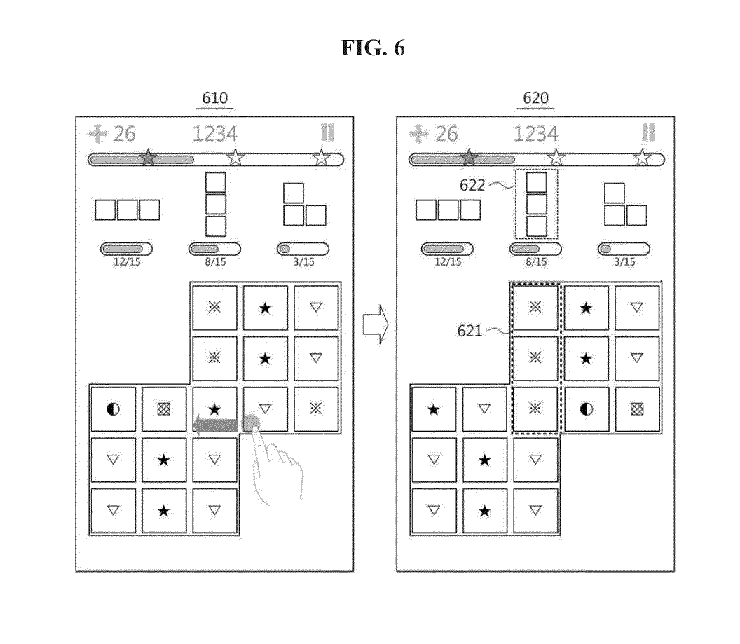

FIG. 6 is a drawing illustrating a process in which a user moves blocks of a block map according to an example embodiment of the inventive concepts. A first puzzle game screen 610 displays an example in which a user generates a touch & drag event for moving two sections in a left direction of blocks in a third row. A second puzzle game screen 620 displays an example in which the two sections are moved in the left direction of blocks in the third row according to the touch & drag event. As described above, two blocks which disappear to the left end of the block map may be disposed on a blank space which occurs by moving the blocks on the third row.

As described above, blocks which disappear may be disposed on a blank space which occurs after the blocks disappear to the left end of the block map. However, in another example embodiment of the inventive concepts, new blocks may be selected and disposed on a blank space.

In this case, a first dotted box 621 of the second puzzle game screen 620 indicates that the combined blocks each are of the equivalent or same type and are arranged in a desired (or alternatively, predetermined) shape (e.g., a shape of a second dotted box 622).

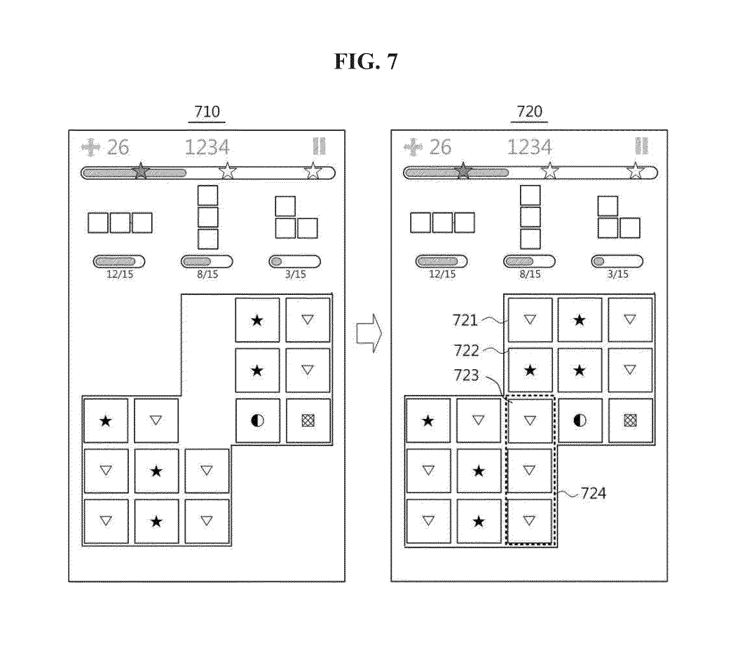

FIG. 7 is a drawing illustrating a process of removing blocks of the equivalent or same type when the blocks each are of the equivalent or same type and are arranged a given or desired shape and a process of making new blocks appear according to an example embodiment of the inventive concepts. A first puzzle game screen 710 of FIG. 7 displays an example in which the blocks having the equivalent or same type and included in a first dotted box 621 are moved on a second puzzle game screen 620 of FIG. 6.

New blocks disposed on an upper end of a blank space may move to the blank space on which blocks are removed, and the new blocks may be disposed on a moved space. Although there are no blocks to move, new blocks may be disposed. FIG. 7 illustrates an example in which there are no blocks to move to an upper end.

In this case, new blocks 721 to 723 may be disposed on a blank space again on a second puzzle game screen 720. In this case, a dotted box 724 of the second puzzle game screen 720 indicates that the blocks each are of the equivalent or same type and are arranged in a given or desired shape by the new block 723.

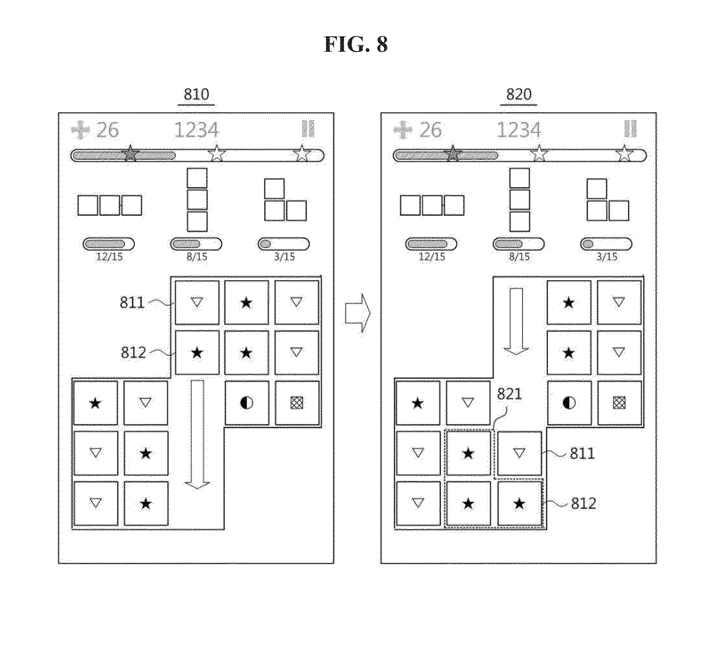

FIG. 8 is a drawing illustrating a process of removing blocks by new blocks according to an example embodiment of the inventive concepts. A first puzzle game screen 810 displays that blocks having a given or desired shape may be deleted on a second puzzle game 720 of FIG. 7 and blocks 811 and 812 located on an upper end of the deleted blocks may move to a space of the deleted blocks.

A second puzzle game screen 820 indicates that the blocks 811 and 812 move to the space of the deleted blocks. In this case, the second puzzle game screen 820 displays that new blocks are disposed on a blank space which occurs after the blocks 812 and 812 are moved.

Whenever blocks move (e.g., whenever blocks move by a user or whenever blocks moves by removing the blocks), a puzzle game system may determine whether the combined blocks each are of the equivalent or same type and are arranged in a desired (or alternatively, predetermined) shape. When the combined blocks each are of the equivalent or same type and are arranged in the desired (or alternatively, predetermined) shape, the puzzle game system may remove the blocks and dispose new blocks. After disposing new blocks, blocks of a star symbol may be arranged in a given or desired shape again as illustrated by a dotted box 821 on the second puzzle game screen 820 according to the movement of the block 812. In such a case, the puzzle game system may remove the three combined blocks of the star symbol and may dispose blocks again.

There may be a limit on the number of times the user may remove blocks. The numeral ‘26’ displayed on a puzzle game screen 100 of FIG. 1 may mean that the user may remove blocks 26 times. A game may be completed when the user remove blocks each of the equivalent or same type and arranged in a given shape 26 times. For example, the numeral “12/15” of a lower end of a given shape on the puzzle game screen 100 may indicate that blocks having the given shape are previously removed 12 times and blocks having the corresponding shape should be removed 15 times more.

The above-described example embodiments of the inventive concepts are described for user input methods in terminals (e.g., a smart phone) having a touch screen. However, the terminals or the user input methods may not be limited to the example embodiment of the inventive concepts in FIG. 1. For example, location information and direction information may be input according to a mouse click & drag event of the user under a personal computer (PC) environment.

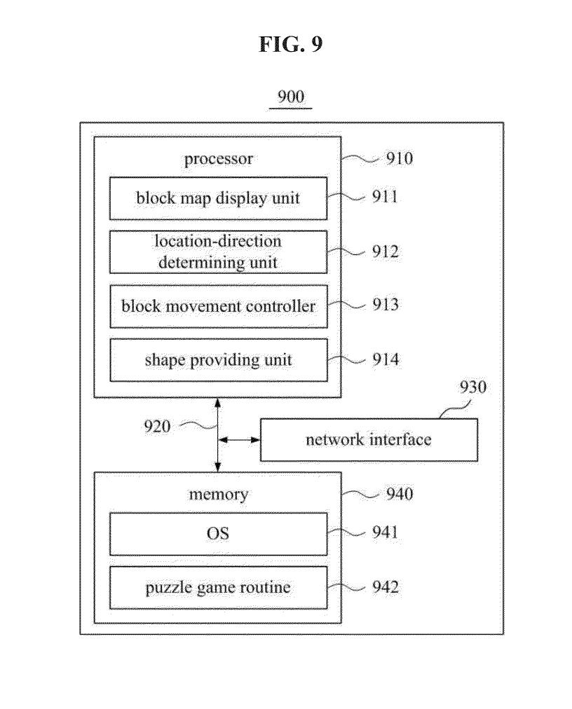

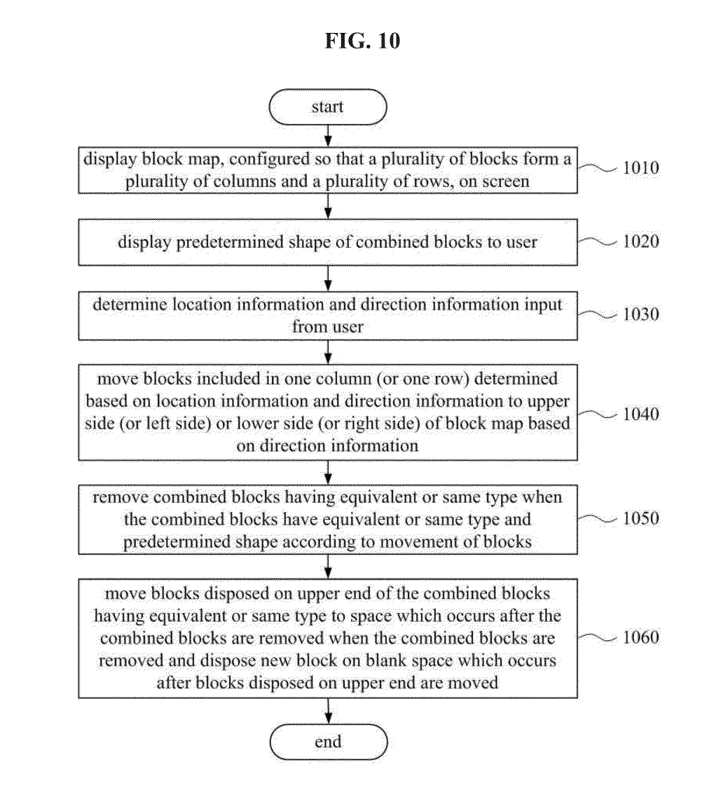

FIG. 9 is a block diagram illustrating a configuration of a puzzle game system according to an example embodiment of the inventive concepts. FIG. 10 is a flowchart illustrating an operation of a puzzle game method according to an example embodiment of the inventive concepts.

A puzzle game system 900 according to an example embodiment of the inventive concepts may correspond to a user terminal which services a puzzle game. As shown in FIG. 9, the puzzle game system 900 may include a processor 910, a bus 920, a network interface 930, a memory 940, and a touch screen 960. The memory 940 may include an operating system (OS) 941 and a puzzle game routine 942. The processor 910 may be configured to include (e.g., by executing computer-readable instructions stored in the memory 940) a block map display unit 911, a location-direction determining unit 912, and a block movement controller 913. For example, the processor 910 may further include a shape providing unit 914. In other example embodiments of the inventive concepts, the puzzle game system 900 may include further elements than those of FIG. 9. For example, the puzzle game system 900 may further include other elements such as a keyboard, and/or a transceiver.

The memory 940 may be a computer-readable medium and may include permanent mass storage devices such as a random access memory (RAM), a read only memory (ROM), and a disc drive. Also, the memory 940 may store program codes for the OS 941 and the puzzle game routine 942. These software elements may be loaded to the memory 940 from a separate non-transitory computer-readable medium which is independent of the memory 940 using a drive mechanism (not shown). The separate non-transitory computer-readable medium may include a computer-readable medium (not shown) such as a floppy drive, a disc, a tape, a Digital Versatile Disc (DVD)/compact disc (CD)-ROM drive, and a memory card. In another example embodiment of the inventive concepts, software elements may be loaded into the memory 940 through the network interface 930 instead of being loaded into the memory from the separate non-transitory computer-readable medium. For example, the puzzle game routine 942 may be loaded into the memory 940 according to programs installed by files provided by developers through a network.

The bus 920 may facilitate communication and data transmission between elements of the puzzle game system 900. The bus 920 may be configured using, for example, a high-speed serial bus, a parallel bus, a storage area network (SAN), and/or other proper communication technologies.

The network interface 930 may be a computer hardware element for connecting the puzzle game system 900 to a computer network. The network interface 930 may connect the puzzle game system 900 to a computer network through a wireless or wired connection.

The touch screen 960 may be driven by the processor 910 to display game screens such as shown in FIGS. 1-8, and to obtain the user input from displayed input interfaces through user touch (e.g., tap, swipe, etc.)

The processor 910 is configured as a special purpose machine by executing instructions of a computer program by performing arithmetic operations, logic operations, and/or an input-output operation of the puzzle game system 900. The instructions may be provided to the processor 910 through the bus 920 from the memory 940 or from the network interface 930. The block map display unit 911, the location-direction determining unit 912, the block movement controller 913, and the shape providing unit 914 included in the processor 910 may be configured to execute program codes or instructions. These program codes may be stored in a recording device (e.g., the puzzle game routine 942) such as the memory 940.

In this case, the processor 910 configured as the block map display unit 911, the location-direction determining unit 912, the block movement controller 913, and the shape providing unit 914 may perform steps 1010 to 1050 of FIG. 10.

In step 1010, the processor 910 may load program codes stored in at least one file of an application for the puzzle game method to a memory (e.g., the memory 940). For example, the at least one file of the application may be provided from file distribution server through a network and be installed the puzzle game system 900. When the application is executed in the puzzle game system 900, the processor 910 may load the program codes (or instructions) from the at least one file to memory.

Each of the block map display unit 911, the location-direction determining unit 912, the block movement controller 913, and the shape providing unit 914 may be configured to execute a corresponding part of the program codes (or instructions) in the memory to process steps 1120 and 1150.

In step 1020, the block map display unit 911 may display a block map on a screen (e.g., the touch screen 960) of the puzzle game system 900. The block map may be configured so that a plurality of blocks form a plurality of columns and a plurality of rows, as previously described with reference to FIGS. 1 to 8.

For example, the block map may be configured so that the number of blocks included in a first column from among a plurality of columns is different from the number of blocks included in a second column from among the plurality of columns or so that the number of blocks included in a first row from among a plurality of rows is different from the number of blocks included in a second row from among the plurality of rows.

In step 1030, the shape providing unit 914 may display one or more desired (or alternatively, predetermined) shapes of combined blocks to a user. This step 1030 may be selectively included in a puzzle game method. For example, in case of a game with a rule of removing the three continuous blocks having the equivalent or same type, a desired shape may not be displayed on the screen of the puzzle game system 900.

In step 1040, the location-direction determining unit 912 may determine location information and direction information input from the user. For one example, the location information may include information about a touch location of a touch & drag event recognized through a touch screen. For another example, the location information may include information about a location according to a click of a mouse click & drag event.

Further, the direction information may include information about a drag direction of a touch & drag event. For another example, the direction information may include information about a drag direction of a mouse click & drag event.

In step 1050, the block movement controller 913 may move blocks included in one column (or one row), which is determined based on the location information and the direction information, to an upper side (or a left side) or a lower side (or a right side) of the block map based on the direction information. The movement may be according to pre-stored movement routines randomly selected by the block movement controller 913.

In this case, step 1050 may include a step (not shown) of disposing blocks which depart or disappear from the upper end (or the left end) of the block map from among the blocks of the one column (or the one row) to a blank space of the lower side (or the right side) of the block map when moving the blocks included in the one column (or the one row) to the upper side (or the left side) of the block map and a step (not shown) of disposing blocks which depart or disappear from the lower end (or the right end) of the block map among the blocks of the one column (or the one row) to a blank space of the upper side (or the left side) of the block map when moving the blocks included in the one column (or the one row) to the lower side (or the right side) of the block map. These steps (not shown) may be performed by the block movement controller 913.

For example, when the puzzle game system 900 includes a touch screen, the block movement controller 913 may move blocks of a column including a block corresponding to a touch location to the upper side or the lower side of the block map when a drag direction of a touch & drag event is the upper side or the lower side. When the drag direction is the left side or the right side, the block movement controller 913 may move blocks of a row including the block corresponding to the touch location to the left side or the right side.

For example, the number of sections (e.g., a moving distance in the number of blocks) by which the blocks of the column (or the row) including the block corresponding to the touch location move may be determined according to a drag degree of a touch & drag event.

Further, a game puzzle method may further include a step 1060, in which the combined blocks are removed when the combined blocks each are of the equivalent or same type and are arranged a desired (or alternatively, predetermined) shape according to movement of blocks. In a step 1070, blocks disposed on an upper end of the combined blocks move to a space which occurs after the combined blocks are removed and new blocks may be disposed on a blank space which occurs by moving the blocks disposed on the upper end. These steps 1060 and 1070 may be performed by the block map movement controller 913.

Accordingly, according to example embodiments of the inventive concepts, the puzzle game system may provide a new puzzle game for moving an entire set of blocks arranged in at least one of one row or one column on the block map, which includes a plurality of blocks arranged in a plurality of columns and a plurality of rows and for removing corresponding blocks when the combined blocks each are of the equivalent or same type and are arranged in a particular shape (e.g., a shape previously given per game instance).

The foregoing devices may be realized by hardware elements, at least one processor executing software elements and/or combinations thereof. For example, the devices and components illustrated in the example embodiments of the inventive concepts may be implemented by a processing circuitry such as a computers, a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described example embodiments of the inventive concepts may be implemented with program instructions which may be executed by various processing circuitry and may be recorded in computer-readable media. The computer-readable media may also include, alone or in combination with the program instructions, data files, data structures, and the like. The program instructions recorded in the media may be designed and configured especially for the example embodiments of the inventive concepts or be known and available to those skilled in computer software. Computer-readable media may include magnetic media such as hard disks, floppy disks, and magnetic tape; optical media such as CD ROM disks and DVDs; magneto-optical media such as floptical disks, and hardware devices which are specially configured to store and perform program instructions, such as a read-only memory (ROM), a random access memory (RAM), a flash memory, and the like. Program instructions may include both machine codes, such as produced by a compiler, and higher-level language codes which may be executed by the computer using an interpreter. The described hardware devices may be configured to as one or more software modules or units to perform the operations of the above-described example embodiments of the inventive concepts, or vice versa.

While a few example embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other example embodiments, and equivalents to claims are within the scope of the following claims.

What is claimed is:

1. A method of performing a puzzle game implemented by a computer, the method comprising:
displaying, by a processor of the computer, a block map on a screen, the block map configured so that a plurality of blocks form a plurality of columns and a plurality of rows;
determining, by the processor, location information and direction information based on input from a user; and
moving, by the processor, blocks in at least one of one column and one row based on the location information and the direction information, to a first side of the block map,
wherein the moving blocks includes,
when moving the blocks in at least one of the one column and the one row to the first side,
controlling some of the blocks in the at least one of the one column and the one row to disappear from a first end of the block map at the first side, and
disposing new blocks of a same number as that of the disappeared blocks on a blank space of a second side of the block map, the second side being opposite to the first side.

2. The method of claim 1, wherein the moving blocks comprises:
disposing the new blocks equivalent to the disappeared blocks on the blank space in a disappearing order the blocks.

3. The method of claim 1, wherein the block map is configured so that
a number of blocks in a first column from among a plurality of columns is different from a number of blocks in a second column from among the plurality of columns, or
a number of blocks in a first row from among a plurality of rows is different from a number of blocks in a second row from among the plurality of rows.

4. The method of claim 1, wherein the plurality of blocks included in the block map are classified into a plurality of different types of blocks, and one or more set shapes of combined blocks are displayed on the screen, and
the method further includes,
when blocks having an equivalent type are combined based on movement of blocks and configured to have the set shape, removing, by the processor, the combined blocks having the equivalent type, and
when the combined blocks having the equivalent type are removed,
moving, by the processor, second blocks on the first end of the removed blocks to a first space generated by the removed blocks, and
disposing, by the processor, new blocks on a second space generated when the blocks on the first end are moved.

5. The method of claim 1, wherein the location information comprises information about a touch location and a drag event recognized by a touch screen,
wherein the direction information includes information about a direction of the drag event, and
wherein the moving blocks includes,
when the direction of the drag event is the first direction, moving blocks of the at least one of the column and the row including a block corresponding to the touch location to the first direction.

6. The method of claim 5, wherein a number of the blocks of the at least one of the column and the row to be moved is determined by a degree of the drag event.

7. A non-transitory computer-readable medium having stored thereon instructions that when executed by a processor to cause a processor to perform the method of claim 1.

8. A puzzle game system implemented with a computer, the system comprising:
at least one processor configured to execute computer-readable instructions which configure the processor to,
move blocks in at least one of one column and one row, the one column (or the row) based on location information and direction information, to a first side of a block map, the block map including a plurality of blocks forming a plurality of columns and a plurality of rows, the location information and the direction information determined based on input from a user,
wherein when moving the blocks included in the at least one of the one column and the one row to the first side, the processor is configured to control some of the blocks in the at least one of the one column and the one row to disappear from a first end of the block map at the first side, and dispose new blocks of a same number as that of the disappeared blocks on a blank space of the second side of the block map, the second side being opposite to the first side.

9. The system of claim 8, wherein the processor is further configured to dispose the new blocks equivalent to the disappeared blocks on the blank space in a disappearing order the blocks.

10. The system of claim 8, wherein the block map is configured so that
a number of blocks in a first column from among a plurality of columns is different from a number of blocks in a second column from among the plurality of columns, or
a number of blocks in a first row from among a plurality of rows is different from a number of blocks in a second row from among the plurality of rows.

11. The system of claim 8, wherein the plurality of blocks included in the block map are classified into a plurality of different types of blocks and one or more set shapes of combined blocks are displayed to the user,
wherein when blocks having an equivalent type are combined based on movement of blocks and configured to have the set shape, the processor is further configured to remove the combined blocks having the equivalent type,
wherein when the combined blocks having the equivalent type are removed, the processor is further configured to move second blocks on the first end of the removed blocks to a first space generated by the removed blocks and dispose new blocks on a second space generated when the blocks on the first end are moved.

12. The system of claim 8, wherein the location information comprises information about a touch location and a drag event recognized by a touch screen,
wherein the direction information includes information about a direction of the drag event,
wherein when the direction of the drag event is the first direction, the processor is further configured to move blocks of the at least one of the one column and the one row including a block corresponding to the touch location to the first direction.

13. The system of claim 8, further comprising:
a touch screen configured to receive a touch input; and
a network interface configured to connect the puzzle game system to a computer network
